(19) United States
(12) Patent Application Publication
(10) Pub. No.: US 2007/0243421 A1
(43) Pub. Date: Oct. 18, 2007

(54) Magnetic Disk Substrate and Production Method of Magnetic Disk

(75) Inventors: Hiroyuki Machida, Chiba (JP); Katsuaki Aida, Chiba (JP); Kazuyuki Haneda, Chiba (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO K.K., Tokyo (JP)

(21) Appl. No.: 11/660,684

(22) PCT Filed: Aug. 26, 2005
(86) PCT No.: PCT/JP05/16049

§ 371 Date: Feb. 21, 2007

Related U.S. Application Data
(60) Provisional application No. 60/606,416, filed on Sep. 2, 2004.

(30) Foreign Application Priority Data
Aug. 27, 2004 (JP) 2004-248568

(51) Int. Cl. G11B 5/62; C03C 19/00

(52) U.S. Cl. 428/846.9; 65/61

(57) ABSTRACT

To reduce a head floating height on a magnetic disk, the invention provides a production method for a magnetic disk substrate capable of efficiently polishing the glass substrate until the degree of flatness (TIR value) of the glass substrate becomes 5 μm or below. The invention relates to a production method, for a magnetic disk substrate, by polishing a glass substrate by lapping by using a lap plate, characterized in that plate accuracy is set to 180 μm or below and polishing is carried out until a degree of flatness (TIR value) of the glass substrate becomes 5 μm or below. A magnetic disk is obtained by forming a magnetic recording layer on this magnetic disk substrate.

### CROSS-REFERENCES TO RELATED APPLICATIONS

This application is an application filed under 35 U.S.C. §111(a) claiming benefit pursuant to 35 U.S.C. §119(e) of the filing date of Provisional Application No. 60/606,416, filed Sep. 2, 2004, pursuant to 35 U.S.C. §111(b).

### TECHNICAL FIELD

This invention relates to a magnetic disk substrate and a production method of a magnetic disk.

### BACKGROUND ART

Magnetic disk devices have made remarkable progress, as external storage devices of computers, owing to their superior cost/performance ratio and further growth is expected. In the magnetic disk devices, a magnetic head flies a predetermined height above a substrate surface when the magnetic disk rotates. This height has become smaller, with the recent requirement for a higher recording density, and the magnetic force of the magnetic head operates on only a small area of a magnetic thin film layer on the substrate and this makes it possible to achieve a higher density. On the other hand, the danger of mis-operations of the devices, due to contact between the magnetic head and the substrate surface, has become higher. To reduce the head floating height (to reduce the glide height), the flatness of the surface of the magnetic disk is important.

An aluminum type substrate has been used in the past as a substrate of a magnetic disk which is mounted in the magnetic disk device, but glass substrates, made of chemically tempered glass and crystallized glass, have gradually gained a wider application because they have high impact resistance and can more easily be made flat. In other words, the aluminum type substrate can easily provide a magnetic disk having excellent magnetic characteristics but involves the problem of flatness because it suffers plastic deformation during a mechanical process such as polishing. In contrast, the glass substrate can be easily made flat because it has high surface hardness and does not involve the plastic deformation described above.

Various studies have been made in the past to reduce the head floating height of the magnetic disk. For example, a method that selects surface roughness of a polishing pad so that microwaviness of the glass substrate reaches a specific value has been proposed (Japanese Unexamined Patent Publication (Kokai) No. 2002-92867). Another method sets the surface roughness of the glass substrate and its microwaviness to a predetermined range/relation (Japanese Unexamined Patent Publication (Kokai) No. 2002-163818). Further, a glass substrate in which microwaviness of the surface has a cycle of 0.1 to 5 mm and amplitude of 0.1 to 1 nm has been proposed (Japanese Unexamined Patent Publication (Kokai) No. 2000-207737).

### DISCLOSURE OF INVENTION

To reduce the head floating height of the magnetic disk, the invention provides a method capable of efficiently polishing a glass substrate so that its degree of flatness (TIR value) becomes 5 μm or below.

To solve the problems described above, the invention provides the following inventions.

(1) A production method of a magnetic disk substrate by polishing a glass substrate by lapping by using a lap plate, characterized in that plate accuracy is set to 180 μm or below and polishing is carried out until a degree of flatness (TIR value) of the glass substrate becomes 5 μm or below.

(2) The production method of a magnetic disk substrate as described in (1), wherein plate accuracy is 150 μm or below.

(3) The production method of a magnetic disk substrate as described in (2), wherein plate accuracy is 80 μm or below.

(4) The production method of a magnetic disk substrate as described in (3), wherein plate accuracy is 50 μm.

(5) The production method of a magnetic disk substrate as described in any of (1) through (4), wherein the degree of flatness (TIR value) of the glass substrate is 4 μm or below.

(6) The production method of a magnetic disk substrate as described in (5), wherein the degree of flatness (TIR value) of the glass substrate is 3 μm or below.

(7) The production method of a magnetic disk substrate as described in any of (1) through (6), wherein a microwaviness value of the glass substrate is 0.5 nm or below.

(8) The production method of a magnetic disk substrate as described in (7), wherein the microwaviness value of the glass substrate is 0.3 nm or below.

(9) A production method of a magnetic disk characterized in that a magnetic recording layer is formed on the magnetic disk substrate as described in any of (1) through (8).

(10) The production method of a magnetic disk as described in (9), wherein a glide avalanche value of the magnetic disk is 5.5 nm or below.

(11) The production method of a magnetic disk as described in (9), wherein a glide avalanche value of the magnetic disk is 3 nm or below.

(12) A magnetic disk substrate for a magnetic disk, produced by a production method according to any of claims 1 through 8.

(13) A magnetic disk produced using a magnetic disk substrate according to any of claims 9 through 11.

To reduce a head floating height of a magnetic disk, the present invention provides a method capable of efficiently conducting polishing so that a degree of flatness (TIR value) of a glass substrate is 5 μm or below.

### BEST MODE FOR CARRYING OUT THE INVENTION

In the production method of a magnetic disk substrate according to the invention, lapping accuracy is set to 180 μm or below and polishing is carried out until the degree of flatness (TIR value) of the glass substrate becomes 5 μm or below when the glass substrate is polished by lapping by using a lap plate.

Amorphous, chemically tempered or crystallized glass, that has generally been used for the magnetic disk substrate, can be used as the glass substrate in the invention. Examples are glasses such as soda lime, aluminosilicate, lithium silicate, lithium aluminosilicate, aluminoborosilicate glasses, and so forth. As the chemically tempered glass, glass that is brought into contact with a molten salt at a high temperature to cause ion exchange of alkali ions in the glass with different kinds of alkali ions in the molten salt and is tempered by the compressive stress is suitable. Examples of the crystallized glass are those which are obtained by re-heating glass under a controlled condition and precipitating and growing a large number of fine crystals. Concrete examples are an Al₂O₃—SiO₂—Li₂O type, a B₂O₃—Al₂O₃—SiO₂—Li₂O type, and so forth. The thickness of such glass substrates is generally selected from the range of about 0.1 to about 2 mm.

In the invention, polishing of the glass substrate is carried out by lapping using a lap plate until the degree of flatness (TIR value) is 5 μm or below, preferably 4 μm or below and further preferably 3 μm or below. Lapping is defined as a pre-process to polishing. Generally, in the case of amorphous and chemical tempered glass, lapping is carried out by abrading the glass substrate surface and the plate through free abrasives dispersed in water, etc. In the case of the crystallized glass, fixed abrasives such as diamond pellets or a diamond plate are used. Examples of the abrasives are aluminum oxide, zirconium oxide, silicon carbide and so forth, but aluminum oxide is suitable from the aspect of a polishing speed, etc. In the invention, lapping itself is carried out in a customary manner but it is necessary to set plate accuracy to 180 μm or below. Adjustment of plate accuracy itself can be done in a customary manner.

Such plate accuracy is selected to preferably 150 μm or below, further preferably to 80 μm or below and most preferably 50 μm or below.

When lapping is conducted in the invention as described above, the degree of flatness (TIR value) of the resulting glass substrate can be easily set to 5 μm or below by setting plate accuracy to 180 μm or below. This degree of flatness (TIR value: Total Indicated Run-out) represents the measurement result of top/valley indicating the difference between the highest point and the lowest point on the substrate surface with respect to a plane that is most optimally fit.

After lapping is applied as described above, an end face of the glass substrate on the inner circumferential side facing an inner diameter hole and an end face on the outer circumferential side are respectively chamfered to give chamfer portions. The end faces of the glass substrate on both inner and outer circumferential sides processed in this way are subjected to polishing into mirror surfaces. Subsequently, the main surface of the glass substrate is finally polished to a mirror surface. Thereafter, the glass substrate is washed and dried in a customary manner and a magnetic disk glass substrate can be acquired.

By this polishing, the microwaviness value of the glass substrate can be easily reduced to 0.5 nm or below, preferably 0.3 nm or below. This microwaviness value means that having a corrugation substrate surface, a cycle in the order of mm and amplitude in the order of nm. It is measured by using an “OPTIFLAT” (product of ADE Phase Shift Co.) (filter 5 mm) and is expressed by a Wa value. The cycle of the microwaviness as the measurement object is 0.1 to 5 mm.

The resulting magnetic disk substrate is used for the production of a magnetic disk in a customary manner. For example, texturing for forming texture grooves in a head traveling direction is first applied to the substrate, whenever necessary. Next, a base film made of a Cr alloy is formed by sputtering on this substrate. A magnetic recording layer made of a Co base alloy is formed to a thickness of about 10 to about 100 nm on this base film. A protective film of carbon, or the like, is preferably formed further on this magnetic recording layer to improve corrosion resistance, sliding resistance, etc. Hydrogenated carbon formed by sputtering or diamond-like carbon by CVD, for example, is formed to a film thickness of about 1 to about 50 nm as this carbon. Perfluoropolyether or a product obtained by esterifying or amidating the terminals of the former is diluted with a solvent and is applied by spraying, dipping, spin coating, etc to a film thickness of about 0.5 to about 5 nm as a lubrication layer to the surface of this carbon protective film, and durability, reliability, etc can be further improved.

When a magnetic disk is produced by using the magnetic disk substrate obtained in this way by the method of the invention, the head floating height on the magnetic disk can be decreased (low glide height). The head floating height on the magnetic disk is expressed by a glide avalanche value and by a floating height value of an inspection head when a protuberance portion of the magnetic disk starts impinging against the inspection head. When the magnetic disk is produced by using the magnetic disk glass substrate according to the invention, a glide avalanche value of 5.5 nm or below, preferably 5 nm or below and further preferably 3 nm or below, can be obtained, for example.

Though the invention will be explained in further detail with reference to Examples thereof, the invention is not limited to these Examples unless the invention exceeds the gist thereof.

In Examples, measurement of microwaviness and a degree of flatness (TIR value) of the substrate, plate accuracy and a glide avalanche value were carried out by using the following measuring apparatuses.

(1) Microwaviness: “OPTIFLAT” (product of ADE Phase Shift Co.)

Cycle of waviness 0.1 to 5 mm

(2) Degree of flatness (TIR value): Laser interference meter type measuring instrument “Zygo” GPI-XP (product of Zygo Co.)

(3) Plate accuracy: commercial plate flatness meter

(4) Glide avalanche value: glide height tester

As for the measurement of the glide avalanche value, the relation between the rotating speed of the magnetic disk and the head floating height was measured in advance. While the inspection head was kept fixed at an arbitrary radius position, the rotating speed of the magnetic disk was gradually changed. When a signal from the inspection head became high, the floating height could be determined from the rotating speed at that time. The rise point was defined as the glide avalanche value.

### EXAMPLE 1

A 2.5-in. lithium silicate type crystallized glass substrate was lapped. The plate accuracy was set to 150 μm by using diamond abrasives. The glass substrate was processed at a number of revolutions of a plate of 15 rpm and a processing pressure of 100 g/cm² (about 9,806 Pa) until a predetermined thickness could be obtained. Next, an end face on the inner circumferential side facing an inner diameter hole and an end face on the outer circumferential side were chamfered; respectively. After the resulting end faces on both inner and outer circumferential sides were polished to mirror surfaces, the main surface of the glass substrate was finally polished to a mirror surface. After being washed, the glass substrate was dried and the microwaviness and the degree of flatness (TIR) were measured. As a result, the microwaviness was 0.375 nm and the degree of flatness (TIR) was 4.98 μm. On the resulting glass substrate were formed serially by sputtering at a substrate temperature of 200° C. a Cr film as a base layer to 60 nm, a Co₁₃Cr₆Pt₃Ta alloy film as a magnetic recording layer to 20 nm and a diamond-like carbon film as a protective layer to 10 nm. Furthermore, a perfluoropolyether lubrication layer was applied by dipping to a thickness of 3 nm, giving a magnetic disk. The glide avalanche value of this magnetic disk was 5.5 nm.

### EXAMPLE 2

A glass substrate and a magnetic disk were produced in the same way as in Example 1 with the exception that plate accuracy was set to 60 μm. The microwaviness of the glass substrate was 0.250 nm and its degree of flatness (TIR) was 2.30 μm. On the other hand, the glide avalanche value of the magnetic disk was 5.0 nm.

### COMPARATIVE EXAMPLE 1

A glass substrate and a magnetic disk were produced in the same way as in Example 1 with the exception that plate accuracy was set to 750 μm. The microwaviness of the glass substrate was 0.909 nm and its degree of flatness (TIR) was 10.04 μm. On the other hand, the glide avalanche value of the magnetic disk was 6.25 nm.

### COMPARATIVE EXAMPLE 2

A glass substrate and a magnetic disk were produced in the same way as in Example 1 with the exception that plate accuracy was set to 325 μm. The microwaviness of the glass substrate was 0.744 nm and its degree of flatness (TIR) was 6.30 μm. On the other hand, the glide avalanche value of the magnetic disk was 5.75 nm.

### INDUSTRIAL APPLICABILITY

To reduce a head floating height on a magnetic disk, the invention provides a method capable of efficiently polishing a glass substrate so that its degree of flatness (TIR value) is 5 μm or below.

1. A production method for a magnetic disk substrate by polishing a glass substrate by lapping using a lap plate, characterized in that plate accuracy is set to 180 μm or below and polishing is carried out until a degree of flatness (TIR value) of said glass substrate becomes 5 μm or below.

2. The production method of a magnetic disk substrate according to claim 1, wherein plate accuracy is 150 μm or below.

3. The production method of a magnetic disk substrate according to claim 2, wherein plate accuracy is 80 μm or below.

4. The production method of a magnetic disk substrate according to claim 3, wherein plate accuracy is 50 μm or below.

5. The production method of a magnetic disk substrate according to claim 1, wherein the degree of flatness (TIR value) of said glass substrate is 4 μm or below.

6. The production method of a magnetic disk substrate according to claim 5, wherein the degree of flatness (TIR value) of said glass substrate is 3 μm or below.

7. The production method of a magnetic disk substrate according to claim 1, wherein a microwaviness value of said glass substrate obtained by polishing is 0.5 nm or below.

8. The production method of a magnetic disk substrate according to claim 7, wherein the microwaviness value of said glass substrate is 0.3 nm or below.

9. A production method of a magnetic disk characterized in that a magnetic recording layer is formed on said magnetic disk substrate according to claim 1.

10. The production method of a magnetic disk according to claim 9, wherein a glide avalanche value of said magnetic disk is 5.5 nm or below.

11. The production method of a magnetic disk according to claim 9, wherein a glide avalanche value of said magnetic disk is 3 nm or below.

12. A magnetic disk substrate for a magnetic disk, produced by a production method according to claim 1.

13. A magnetic disk produced using a magnetic disk substrate according to claim 9.
